(19) United States
(12) Patent Application Publication
(10) Pub. No.: US 2026/0145605 A1
(43) Pub. Date: May 28, 2026

(54) TABLE ASSEMBLY FOR VEHICLE INTERIOR

(71) Applicant: Faurecia India Private Limited, Maharashtra (IN)

(72) Inventors: Rahul SODMISE, Maharashtra (IN); Shreyash CHOUGULE, Maharashtra (IN)

(21) Appl. No.: 19/399,623

(22) Filed: Nov. 24, 2025

(30) Foreign Application Priority Data
Nov. 25, 2024 (IN) 202421091813

(51) Int. Cl. B60N 3/00

(52) U.S. Cl. CPC B60N 3/002

(57) ABSTRACT

A table assembly (100) for a vehicle interior. The table assembly (100) includes a tray (102) movably arranged within or on a housing (104) of the vehicle interior, and a spring-loaded plunger (202) arranged between the tray (102) and the housing (104). The tray (102) is slidable between a first position and a second position. In the first position, the tray (102) is locked or latched to the housing (104), and wherein in the second position, the spring-loaded plunger (202) causes the tray (102) to at least partially move away from the first position once the tray (102) is unlocked or unlatched from the housing (104).

### TECHNICAL FIELD

The present disclosure relates to the field of slidable table/tray assembly for a vehicle interior.

### BACKGROUND

This background description includes information that may be useful in understanding the present invention. It is not an admission that any of the information provided herein is prior art or relevant to the presently claimed invention, or that any publication specifically or implicitly referenced is prior art.

In modern vehicles, there is an increasing demand for ergonomic and functional storage solutions to enhance user convenience, especially in the vehicle interior. One such solution involves the integration of a table assembly having slidable instrument panel (IP) trays in the vehicle interior, which can be seamlessly stowed within the dashboard and pulled out when required by the user. The table assembly provides utility space for passengers and drivers, allowing the placement of items such as laptops, electronic devices, personal belongings, or documents.

However, while these slidable trays offer utility, they should also present safe use.

### SUMMARY

There is, therefore, a need to overcome the above drawbacks and shortcomings associated with existing solutions by providing an improved table assembly and slidable tray mechanism that addresses safety and/or design complexity, ensuring secure operation while maintaining ease of use.

Some of the objects of the present disclosure, which at least one embodiment herein satisfies are as listed herein below.

It is an object of the present disclosure to provide an improved table assembly with a slidable tray that enhances user convenience through seamless stowage and accessibility.

The present disclosure relates to the field of slidable tray/table assembly for a vehicle interior. More particularly, the present disclosure relates to a simple, improved, and cost-effective table assembly with a slidable tray for the vehicle interior, which enhances user convenience through seamless stowage and accessibility, while also ensuring safety during vehicle motion.

An aspect of the present disclosure pertains to a table assembly for a vehicle interior. The table assembly may comprise a tray movably arranged within or on a housing in the vehicle interior, and a spring-loaded plunger arranged between the tray and the housing, where the tray is slidable between a first position and a second position. In the first position, the tray may be locked or latched to the housing. Further, in the second position, the spring-loaded plunger may cause the tray to at least partially move the tray away from the first position once the tray is unlocked or unlatched from the housing.

In an aspect, in the first position, a spring associated with the spring-loaded plunger remains in a compressed state with a first end of the plunger biased toward the second position of the tray. Further, once the tray is unlocked or unlatched from the housing, the spring moves to an uncompressed state and correspondingly enables the movement of the tray from the first position to the second position. The shaft can be a cylindrical-shaped structure. More particularly, the spring associated with the spring-loaded plunger is positioned about/around a shaft having a first end and a second end. The shaft is extending along a longitudinal axis of the plunger. Further, a first disc can be integrally formed or attached about/around the shaft between the spring and the first end of the shaft. A frame with a front wall and a rear wall can be arranged on the housing or the tray. Wherein the front wall may include a first slot and the rear wall may include a second slot. Further, the spring and the first disk of the spring-loaded plunger are arranged between the front and rear wall of the frame such that the spring moves to a compressed state when the tray is displaced toward the housing or towards the first position, and the spring returns to an uncompressed state when the tray is unlocked or latched from the housing. Wherein a second disk can be formed on the first end of the shaft which is biased towards the second position of the tray.

In an aspect, the tray in the second position is adapted to be gripped by a user and further slidably moved from the second position to a third position by pulling the tray further away from the housing.

In an aspect, the first position corresponds to a stowed position in which the tray remains within the housing with a distal surface of the tray substantially flushed with an outer surface of the housing.

In an aspect, the second position corresponds to a partially stowed position in which a greater part of the tray remains within the housing with a distal surface of the tray substantially accessible to a user at the outer surface of the housing. The third position corresponds to a usage/table position in which the user may use the top surface of the tray as a work/holding surface.

In an aspect, the housing is arranged in a dashboard or is an integral part of the dashboard of the vehicle interior. In the present aspect, the tray is slidable in a longitudinal direction of the vehicle interior.

In an aspect, the tray may be locked or latched to the housing via a locking system. The locking system may comprise a first locking rod adapted to be arranged between the housing and the tray substantially extending along a width of the housing or the tray, and a second locking rod adapted to be arranged between the housing and the tray substantially extending along a width of the housing, and a rotating member rotatably fixed in or on the housing or the tray and adapted to be connected to the first locking rod and the second locking member. Accordingly, upon actuation of the locking system, the rotating member may rotate to facilitate movement of the first locking rod and the second locking rod towards each other to unlock or unlatch the tray from the housing. In an aspect, locking end portions of the both the locking rods has an inclined surface such that upon pushing the tray to the first position, the rods locked into an opening of the tray or the housing respectively.

In an aspect, the tray is slidable in a direction along a longitudinal axis of the plunger or along a first direction substantially perpendicular to the width of the housing or the tray.

In an aspect, the spring associated with the spring-loaded plunger is positioned about/around a (cylindrical) shaft having a first end and a second end. The shaft is extending along a longitudinal axis of the plunger. The plunger further includes a first disc integrally formed or attached near the first end of the cylindrical shaft. In an aspect, the first disc has a diameter greater than that of the cylindrical shaft and extends perpendicularly to the longitudinal axis. Further, the plunger includes a second disc integrally formed or attached about/around the shaft at a position between the first end and the second end of the shaft. In an aspect, the second disc has a diameter greater than that of the cylindrical shaft.

In an aspect, the table assembly comprises a frame with a front wall and a rear wall, which is arranged on the housing or the tray. Further, the front wall includes a first slot and the rear wall includes a second slot such that the spring and the first disk of the spring-loaded plunger are arranged between the front and rear wall of the frame such that the spring moves to a compressed state when the tray is displaced toward the housing or towards the first position, and the spring returns to an uncompressed state when the tray is unlocked or latched from the housing. More particularly, the spring is a coil spring.

Further, the first slot is a V-shaped slot at a distal top end of the front wall of the frame and the second slot is a circular slot at a distal end of the rear wall of the frame. The second end of the shaft is adapted to be inserted within the cavity and extended out of the frame via the circular slot, with the first slot or V-shaped slot restricting the second disc within the frame and the spring positioned around the shaft between the V-shaped slot and the circular slot of the frame.

In an aspect, the table assembly comprises a set of guide rails or channels extending along the lateral sides of the housing and a set of rollers extending along the lateral sides of the tray. The set of rollers slidably engages with the set of guide rails or channels to facilitate slidable movement of the tray with respect to the housing.

In an aspect, the table assembly comprises a sensor positioned in or on the housing to monitor the movement of the tray between the first position, the second position, and the third position. The table assembly further comprises a controller in communication with the sensor and the locking system of the vehicle. The controller is configured to issue an actuation signal to an actuator associated with the locking system to switch the locking system to the unlocked position. In another aspect, the controller is configured to issue an actuation signal to an actuator associated with the locking system to switch the locking system between the locked position and the unlocked position

In an aspect, the controller is operatively connected to an ignition system of the vehicle. The controller is configured to issue an alert signal to the ignition system to restrict the ignition of an engine of the vehicle when the tray is in the second position or the third position and issue an activation signal to the ignition system to allow ignition of the engine when the tray is in the first position.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A to 1C illustrate exemplary views of the proposed table assembly installed in the vehicle interior, in accordance with an embodiment of the present invention.

FIG. 1D illustrates an exemplary block diagram of the proposed table assembly, in accordance with an embodiment of the present invention.

FIGS. 2A to 2D illustrate exemplary detailed views of the spring-loaded plunger arrangement configured between the tray and the housing of the table assembly, in accordance with an embodiment of the present invention.

FIGS. 3A to 3D illustrate exemplary views of the plunger, frame, and spring associated with the table assembly, in accordance with an embodiment of the present invention.

FIG. 4 illustrates an exemplary view of the locking system associated with the table assembly, in accordance with an embodiment of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to the field of slidable tray assemblies. More particularly, the present disclosure relates to a simple, improved, and cost-effective table assembly with a slidable tray for the vehicle interior, which enhances user convenience through seamless stowage and accessibility, while ensuring safety during vehicle motion.

According to an aspect, the present disclosure elaborates upon a table assembly for a vehicle interior. The table assembly comprises a tray movably arranged within or on a housing in the vehicle interior, and a spring-loaded plunger arranged between the tray and the housing, where the tray is slidable between a first position and a second position. In the first position, the tray is locked or latched to the housing. Further, in the second position, the spring-loaded plunger causes the tray to at least partially move the tray away from the first position once the tray is unlocked or unlatched from the housing.

In an embodiment, in the first position, a spring associated with the spring-loaded plunger remains in a compressed state with a first end of the plunger biased towards the second position of the tray such that, once the tray is unlocked or unlatched from the housing, the spring moves to an uncompressed state and correspondingly enables the movement of the tray from the first position to the second position.

In an embodiment, the tray in the second position is adapted to be gripped by a user and further slidably moved from the second position to a third position by pulling the tray away from the housing.

In an embodiment, the first position corresponds to a stowed position in which the tray remains within the housing with a distal surface of the tray substantially flushed with an outer surface of the housing.

In an embodiment, the housing is arranged in a dashboard or is an integral part of the dashboard of the vehicle interior.

In an embodiment, the tray is locked or latched to the housing via a locking system. The locking system comprises a first locking rod adapted to be arranged in between the housing and the tray, substantially extending along a width of the housing, a second locking rod adapted to be arranged between the housing and the tray, substantially along a width of the housing, and a rotating member rotatably fixed on the housing or the tray and adapted to be connected to the first locking rod and the second locking member. Accordingly, upon actuation of the locking system, the rotating member rotates to facilitate movement of the first locking rod and the second locking rod towards each other to unlock or unlatch the tray from the housing.

In an embodiment, the tray is slidable in a direction along a longitudinal axis of the plunger or along a first direction substantially perpendicular to the width of the housing or the tray.

In an embodiment, the spring of the spring-loaded plunger is positioned around a shaft extending along a longitudinal axis of the plunger, where the shaft includes a first end and a second end. Further, a first disc is integrally formed on or attached to the shaft about/around the shaft between the spring and the first end of the shaft.

In an embodiment, a frame with a front wall and a rear wall is mounted on either the housing or the tray. The front wall of the frame includes a first slot, and the rear wall includes a second slot. A spring and the first disk of a spring-loaded plunger are positioned between the front and rear walls of the frame. When the tray is displaced towards the housing or moved into the first position, the spring compresses. Conversely, when the tray is unlocked or unlatched from the housing, the spring returns to an uncompressed state.

In an embodiment, the first slot is a V-shaped slot located at the distal top end of the frame, and the second slot is a circular slot at the proximal end of the frame. A second end of the shaft is designed to be inserted into the second slot via the circular slot, with the V-shaped slot restricting the second disc within the frame. The spring is positioned around the shaft between the V-shaped slot and the circular slot of the frame.

In an embodiment, the table assembly comprises a set of guide rails or channels extending along the lateral sides of the housing and a set of rollers extending along the lateral sides of the tray. The set of rollers slidably engages with the set of guide rails or channels to facilitate slidable movement of the tray with respect to the housing.

In an embodiment, the table assembly comprises a sensor positioned in or on the housing to monitor the movement of the tray between the first position, the second position, and the third position. The table assembly further comprises a controller in communication with the sensor and the locking system of the vehicle. The controller is configured to issue an actuation signal to an actuator associated with the locking system to switch the locking system between the locked position and the unlocked position.

In an embodiment, the controller is operatively connected to an ignition system of the vehicle. The controller is configured to issue an alert signal to the ignition system to restrict the ignition of an engine of the vehicle when the tray is in the second position or the third position and issue an activation signal to the ignition system to allow ignition of the engine when the tray is in the first position.

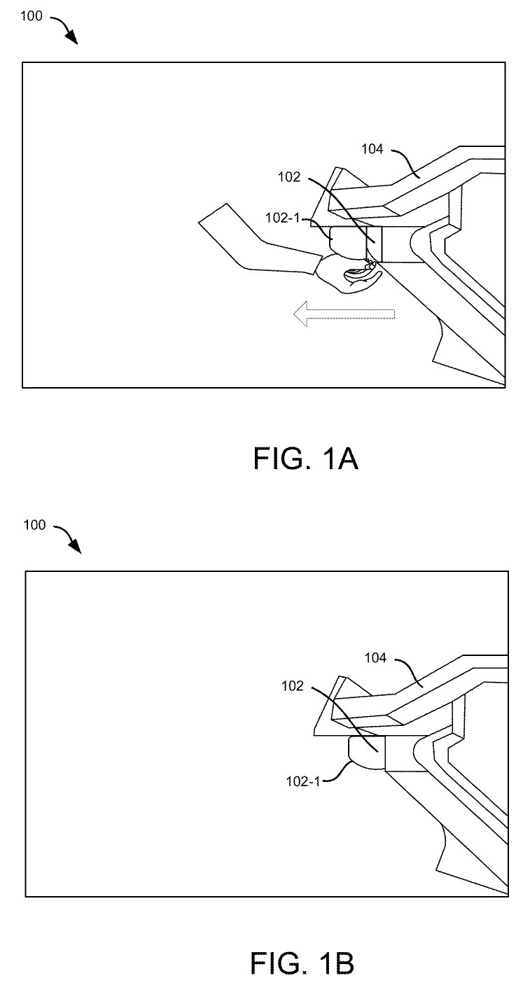

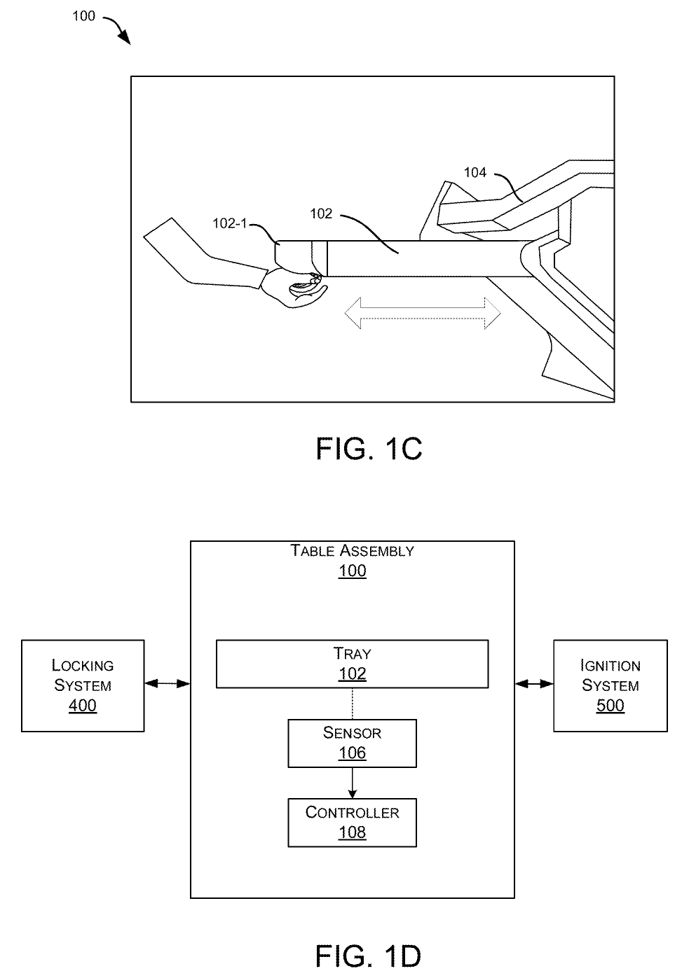

Referring to FIGS. 1A to 3D, a table assembly 100 for the vehicle interior is disclosed. The table assembly 100 can include a tray 102 having a substantially planar profile movably arranged within or on a housing 104 in the vehicle interior. The tray 102 can be adapted to be moved between a first position (also known as a stowed position), as shown in FIG. 1B, a second position (also referred to as a partially stowed position, a gripping position, or an intermediate position) as shown in FIG. 1A, and a third position (also referred to as table or fully extended or deployed position) as shown in FIG. 1C with respect to the housing 104. In the first (stowed) position, the tray 102 remains secured within or on the housing 104 such that a distal end 102-1 of the tray 102 remains flush with a (visible) distal (outer) surface of the housing 104. Further, in the second (gripping position) position, at least a portion (not complete tray 102) at the distal end 102-1 of the tray 102 extends outside or away from the housing 104, which allows users (occupants) in the vehicle to manually grip, pull, and push the tray 102. Furthermore, in the third (fully extended) position, the tray 102 extends out of the housing 104 and allows the occupants to use the tray 102. In an embodiment, the tray 102 can be slidable between the first position, the second position, and the third position in a direction along a longitudinal axis of the plunger 202 or vehicle interior or along a first direction A-A’ perpendicular to the width W-W’ of the housing 104.

In an embodiment, the housing 104 can be arranged in a dashboard of the vehicle interior but is not limited to the like. However, in another embodiment, the housing 104 can be an integral part of the dashboard of the vehicle interior. In an exemplary embodiment, the distal end (visible surface) 104-1 of the housing 104 can include an open section in which the tray 102 can be inserted and movably arranged within the housing 104 using a sliding mechanism. Accordingly, the tray 102 can slide between different positions with respect to the housing 104 via the open section. Further, in another exemplary embodiment (not shown), the tray 102 can be movably arranged on the top or bottom surface of the housing 104 using the sliding mechanism. The dimension (shape, width, height, and length) of the tray 102 may be selected based on the profile and dimension of the housing 104, which may allow the tray 102 to be securely moved between different positions without damaging the housing 104.

In an embodiment (not shown), the table assembly 100 can include a set of guide rails or channels extending along the lateral sides of the housing 104 and a set of rollers extending along the lateral sides of the tray 102. The set of rollers can slidably engage with the guide rails or channels to facilitate slidable movement of the tray 102 with respect to the housing 104.

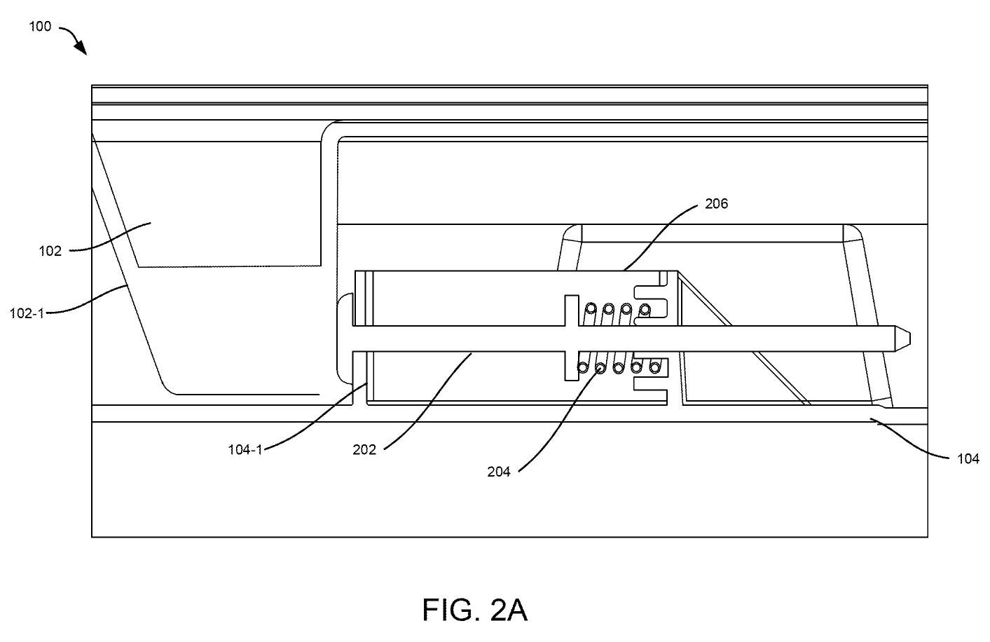

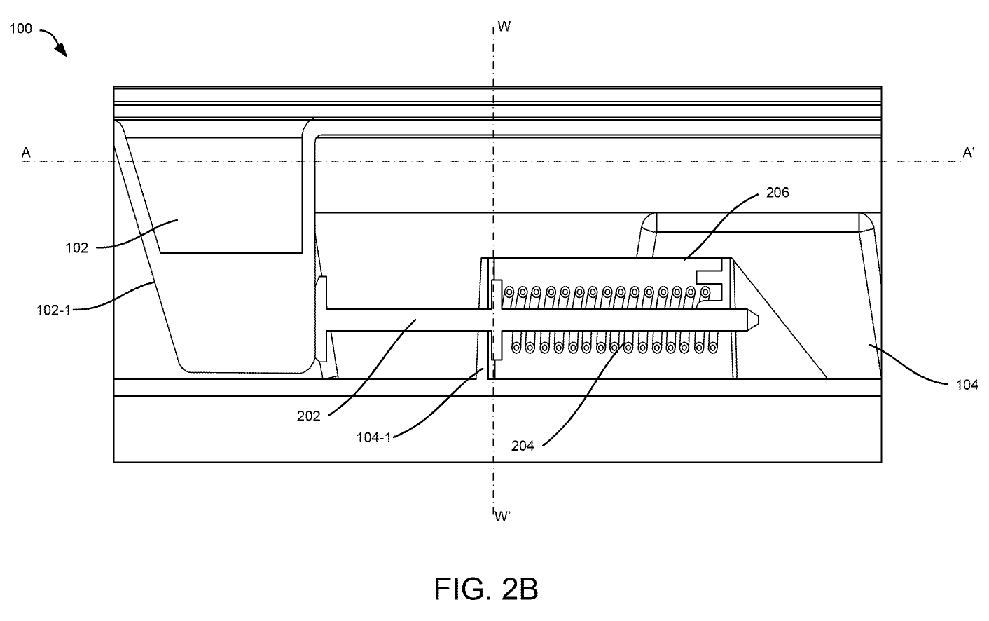

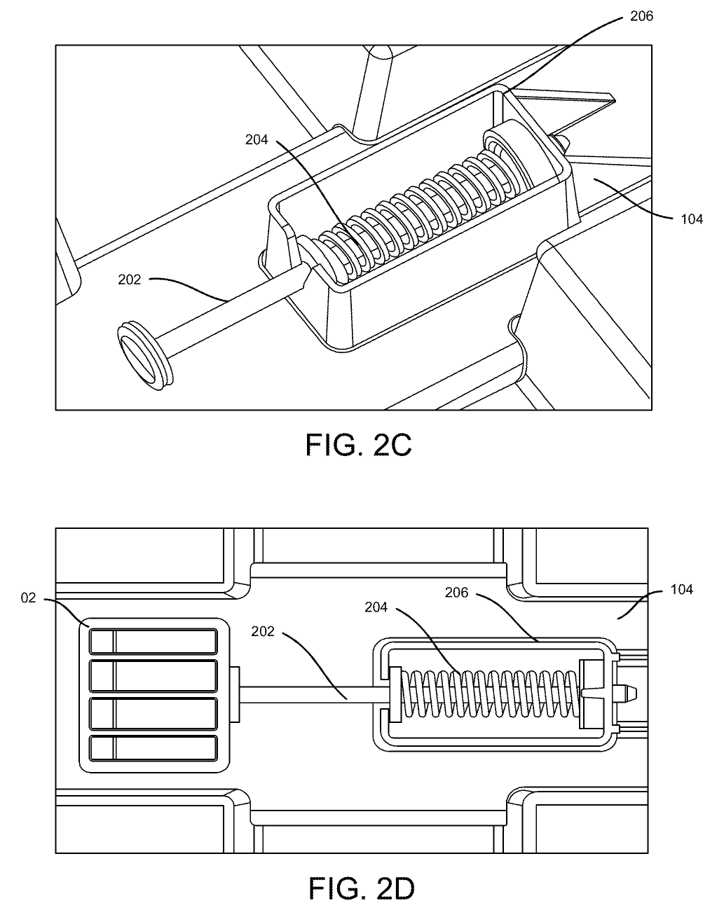

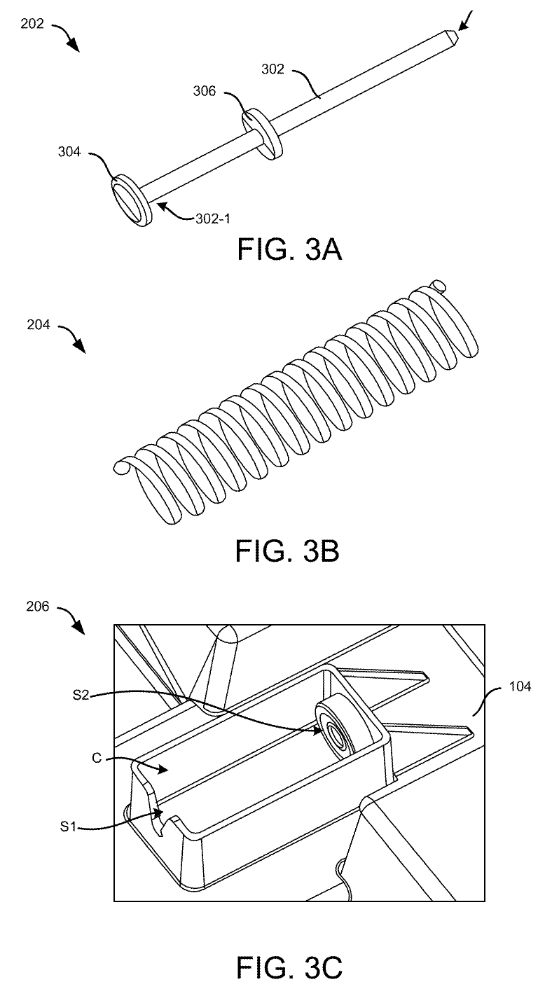

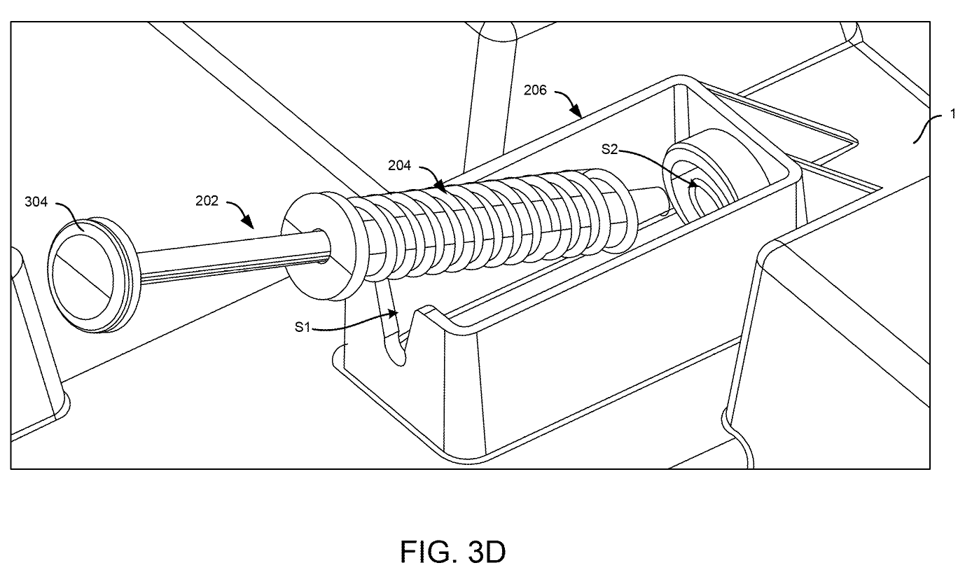

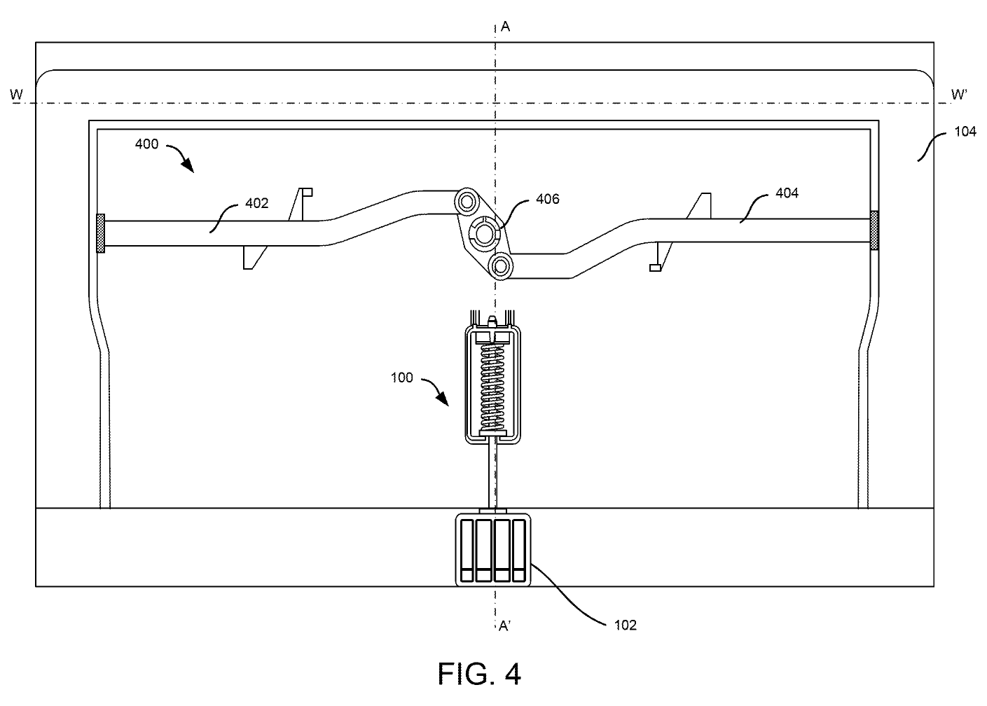

In an embodiment, a spring-loaded plunger 202 can be arranged between the tray 102 and the housing 104, which may allow the tray 102 to be slidably moved between the first (stowed) position and the second (gripping) position, without directly moving to the third (fully extended) position. The detailed construction and functioning of the spring-loaded plunger 202 have been described later in conjunction with FIGS. 2A to 3D. In the first position, the tray 102 can be locked or latched to the housing 104 using a locking system 400 as shown in FIG. 4. Further, in the second position, the spring-loaded plunger 202 can cause the tray 102 to at least partially move the tray 102 away from the first position (and not directly to the third position) once the tray 102 is unlocked or unlatched from the housing 104. This may ensure that the table assembly 100 is designed with safety considerations, preventing the complete sliding out of the tray 102 to avoid obstruction of driver operations, distractions, or potential injury to occupants.

Referring to FIG. 2A to 3D, in an embodiment, the plunger 202 can include a cylindrical shaft 302 having a first end 302-1 and a second end 302-2. The plunger 202 can further include a second disc 304 integrally formed or attached near the first end of the cylindrical shaft 302, where the second disc 304 can have a diameter greater than that of the cylindrical shaft 302 and extend perpendicularly to the longitudinal axis. Further, the plunger 202 can include a first disc 306 integrally formed or attached on the cylindrical shaft 302 at a position between the first end 302-1 and the second end 302-2 of the shaft 302, where the first disc 306 can have a diameter greater than that of the cylindrical shaft 302.

Further, in an embodiment, the table assembly 100 can include a frame 206 with an open top configured on the housing 104 and adapted to partially enclose the spring-loaded plunger 202. The frame 206 can include a cavity C that guides the linear movement of the plunger 202 along the longitudinal axis A-A’ of the spring-loaded plunger 202. Further, a coil spring 204 can be positioned around the shaft 302 of the plunger 202 between the first disc 306 and the second end 302-2 of the plunger 202 in the cavity C of the frame 206, with the second disc 304 positioned at the first end 302-1 and configured outside of the housing 104 and the first disc 306 positioned within the plunger frame 206, allowing for external manual actuation of the plunger 202 upon movement of the tray 102 towards the first (stowed) position. As a result, the spring 204 can move to a compressed state when the first disc 304 is displaced toward the housing 104 as shown in FIG. 2A, and the spring 204 can return to an uncompressed state when the external force is released as shown in FIG. 2B.

The frame 206 can include a first/V-shaped slot S1 at the distal top end of a front wall of the frame 206 and a second/circular (through) slot S2 at a rear wall of the frame 206. The second end 302-2 of the shaft 302 can be adapted to be inserted within the second/circular slot S2 and extended out of the circular slot S2, with the first / V-shaped slot S1 restricting the first disc 306 and the spring 204 to move out of the front and rear wall of the frame 206. The V-shaped slot S1 also facilitates placing the plunger 202 in the cavity C while inserting the second end 302-2 of the shaft 302 out of the frame 206 via the circular slot S2.

Thus, in the first position, the spring 204 associated with the spring-loaded plunger 202 can remain in a compressed state with the first end or more particularly the second disk 304 of the plunger 202 biased towards the tray 102 or the second position as shown in FIG. 2A. Further, once the tray 102 is unlocked or unlatched from the housing 104, the spring 204 can move to the uncompressed state and correspondingly enable movement of the tray 102 from the first position to the second position as shown in FIG. 2B.

Referring to FIG. 4, in an embodiment, the tray 102 can be locked or latched to the housing 104 via the locking system 400. In the present embodiment, the locking system 400 can include a rotating member 406, a first locking rod 402, and a second locking rod 404. The first locking rod 402 is adapted to be arranged in between the housing 104 and the tray 102 along a width W-W’ of the housing 104, and the second locking rod 404 adapted to be arranged in between the housing 104 and the tray along the width W-W’ of the housing 104. The rotating member 406 is rotatably fixed in or on the housing 104 and adapted to be connected to the first locking rod 402 and the second locking rod 404 as shown in FIG. 4, in this embodiment only the tray is slidable. In an alternative embodiment (not shown), the rotating member 406 can be rotatably fixed in or on the tray 102 and adapted to be connected to the first locking rod 402 and the second locking rod 404 in this embodiment the tray is slidable along with the locking system 400.

Accordingly, upon actuation of the locking system 400, the rotating member 406 can rotate to facilitate the movement of the first locking rod 402 and the second locking rod 404 towards each other along the width W-W’ of the housing 104 to unlock or unlatch the tray 102 from the housing 104. Further, upon release of the locking system 400, the rotating member 406 can rotated back to its nominal position such that upon pushing the tray towards the first position the first and second rods 402, 404 may lock/latch the tray 102 with an opening provided on the tray 102.

Referring back to FIG. 1D, in an embodiment, the table assembly 100 can include a sensor 106 positioned in or on the housing 104 to monitor the movement of the tray 102 between the first position, the second position, and the third position. The table assembly 100 can further include a controller 108 in communication with the sensor 106 and the locking system 400 of the vehicle. Further, the controller 108 can also be operatively connected to an ignition system 500 of the vehicle. The controller 108 can include one or more processors coupled to a memory storing instructions executable by the processors, which may cause the controller to perform one or more designated operations. In an embodiment, the controller 108 can be an electronic control unit (ECU) of the vehicle. However, the controller 108 can also be in communication with the ECU of the vehicle. In addition, the controller 108 can include an interface. The interface can facilitate communication through the assembly 100. The interface can provide a communication pathway for other components of the assembly 100 coupled to the controller through a communication unit integrated within the controller 108. The communication unit can facilitate data exchange between the controller 108 and the other components such as the sensor 106, the locking system 400, and the ignition system 500.

In an embodiment, the controller 108 can be configured to issue an actuation signal to an actuator associated with the locking system 400 to switch the locking system to the unlocked position. The locking system is actuated by an electric motor or alike. The table assembly 100 may include a button connected to the controller 108 and provided on the table assembly 100, which may allow the occupants to switch the locking system 400 to the unlocked position. However, the table assembly 100 may also allow the occupants to switch the locking system 400 using a human-machine interface (HMI) device installed in the vehicle and/or using mobile devices associated with the occupants.

Further, in an embodiment, the controller 108 can be configured to issue an alert signal to the ignition system 500 to restrict the ignition of an engine of the vehicle when the tray 102 is in the second position or the third position and issue an activation signal to the ignition system 500 to allow ignition of the engine when the tray 102 is in the first position. This may restrict sliding out of the tray 102 or help keep the tray 102 stowed when the vehicle is in motion, thereby avoiding obstruction of driver operations, distractions, or potential injury to occupants.

While various embodiments have been described herein for the proposed table assembly installed in vehicle interior, however, the table assembly may also be installed in non-vehicular components without departing from the scope of this invention.

Thus, in various embodiments the present invention overcomes the above drawbacks and shortcomings associated with existing solutions by providing an improved table assembly and slidable tray mechanism that addresses both safety and design complexity, ensuring secure operation while maintaining ease of use.

While various embodiments and drawings have been described herein for the trim part being a door assembly and the trim assembly being a map pocket, however, the teachings of the subject disclosure are equally applicable to other trim parts and trim assembles present in vehicle interior, without departing from the scope of this invention.

Thus, various embodiments of this invention provide a robust, easy-to-assemble, and improved solution for securing the reinforcement member to the panel associated with trim assembles such as map pockets in the vehicle interior. This invention can provide a cost-effective solution for assembling map pockets and other trim assemblies in vehicle interiors, eliminating the reliance on vibration and noise-causing traditional snap-fit mechanisms and other complex assembly procedures, and minimizing the welding requirements and the overall carbon emission.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

Some embodiments of the proposed invention provide an improved table assembly with a slidable tray for vehicle interiors that enhances user convenience and utility by allowing seamless stowage and easy access to a placement space for items such as laptops, electronic devices, personal belongings, or documents.

Some embodiments of the proposed invention ensure that the table assembly is designed with safety considerations, preventing the complete sliding out of the tray to avoid obstruction of driver operations, distractions, or potential injury to occupants.

Some embodiments of the proposed invention restricts sliding out of the tray or keeps the tray stowed when the vehicle is in motion, thereby avoiding obstruction of driver operations, distractions, or potential injury to occupants.

Some embodiments of the proposed invention reduces the complexity of existing actuation mechanisms employed in table assembly by designing a simplified, less bulky, and more cost-effective assembly that consists of fewer components, improving the overall reliability and reducing the weight of the structure.

Some embodiments of the proposed invention provides a table assembly with a slidable tray that minimizes manufacturing and maintenance costs by reducing the number of parts, thereby streamlining production and making repairs or replacements easier and less time-consuming.

1. A table assembly for a vehicle interior, the table assembly comprising:
a tray movably arranged within or on a housing of the vehicle interior; and
a spring-loaded plunger arranged between the tray and the housing, wherein the tray is slidable between a first position and a second position,
wherein in the first position, the tray is locked or latched to the housing, and wherein in the second position, the spring-loaded plunger causes the tray to at least partially move the tray away from the first position once the tray is unlocked or unlatched from the housing.

2. The table assembly as claimed in claim 1, wherein in the first position, a spring associated with the spring-loaded plunger remains in a compressed state with a first end of the plunger biased towards the second position of the tray such that, once the tray is unlocked or unlatched from the housing, the spring moves to an uncompressed state and correspondingly enables movement of the tray from the first position to the second position.

3. The table assembly as claimed in claim 1, wherein the tray in the second position is adapted to be gripped by a user and further slidably moved from the second position to a third position by pulling the tray away from the housing.

4. The table assembly as claimed in claim 1, wherein the first position corresponds to a stowed position in which the tray remains within the housing with a distal surface of the tray substantially flushed with an outer surface of the housing.

5. The table assembly as claimed in claim 1, wherein the housing is arranged in a dashboard or is an integral part of the dashboard of the vehicle interior.

6. The table assembly as claimed in claim 1, wherein the tray is locked or latched to the housing via a locking system, wherein the locking system comprises:
a first locking rod adapted to be arranged between the housing and tray substantially extending along a width of the housing;
a second locking rod adapted to be arranged between the housing and tray substantially extending along a width of the housing; and
a rotating member rotatably fixed on the housing or the tray and adapted to be connected to the first locking rod and the second locking member, wherein upon actuation of the locking system, the rotating member rotates to facilitate movement of the first locking rod and the second locking rod towards each other to unlock or unlatch the tray from the housing.

7. The table assembly as claimed in claim 1, wherein the tray is slidable in a direction along a longitudinal axis of the plunger or along a first direction substantially perpendicular to the width of the housing or the tray.

8. The table assembly as claimed in claim 2, wherein the spring of the spring-loaded plunger is positioned about/around a shaft extending along a longitudinal axis of the plunger, the shaft includes a first end and a second end; and
a first disc integrally formed on or attached to the shaft about/around the shaft between the spring and the first end of the shaft.

9. The table assembly as claimed in claim 8, wherein a frame with a front wall and a rear wall is arranged on the housing or the tray, wherein the front wall includes a first slot and the rear wall includes a second slot such that the spring and the first disk of the spring-loaded plunger is arranged between the front and rear wall of the frame such that the spring moves to a compressed state when the tray is displaced toward the housing or towards the first position, and the spring returns to an uncompressed state when the tray is unlocked or latched from the housing.

10. The table assembly as claimed in claim 9, wherein the first slot is a V-shaped slot at a distal top end of the frame and the second slot is a circular slot at a proximal end of the frame, wherein a second end of the shaft is adapted to be inserted into the second slot that is via the circular slot with the first slot or V-shaped slot restricting the second disc within the frame and the spring positioned around the shaft between the V-shaped slot and the circular slot of the frame.
